(19) United States
(12) Patent Application Publication
(10) Pub. No.: US 2020/0288636 A1
(43) Pub. Date: Sep. 17, 2020

(54) DEVICE FOR HANDLING OBJECTS

(71) Applicant: Xihelm Limited, London (GB)

(72) Inventors: James KENT, Lodon (GB); Clement THOREY, LodonLodon (GB)

(73) Assignee: Xihelm Limited, London (GB)

(21) Appl. No.: 16/632,413

(22) PCT Filed: Jul. 19, 2018
(86) PCT No.: PCT/GB2018/052038

§ 371 Date: Jan. 20, 2020

(30) Foreign Application Priority Data
Apr. 21, 2017 (GB) 1711768.0

(51) Int. Cl. A01D 46/00; A01D 46/30

(52) U.S. Cl. CPC A01D 46/005; A01D 46/247; A01D 46/30

(57) ABSTRACT

The present invention relates to a device for handling fresh fruit or vegetable products attached to a plant, comprising: means for retaining at least a first portion of a product; and means for engaging a second portion of the retained product; wherein the retaining means and engaging means are arranged such that, while a product is retained by the retaining means, the engaging means can be moved to detach the product.

The present invention relates to a device for handling objects. In particular, the invention relates to a device for handling fruit or vegetable products. More specifically, the invention relates to an end-effector device for a robot (arm).

Seasonal labour availability is a concern in the produce growing industry, which can increase production costs and lower the competitiveness of fruit and vegetable growers. To address this concern, various apparatus and devices have been devised to perform tasks across agriculture, including the automation of picking fruit and vegetables. However, a large number of fruit and vegetables still have to be picked by human hand, such as premium on-the-vine varieties of tomatoes, because existing devices (for example, robot end-effectors) either cannot handle the variety of fruit or cause damage to the fruit or the plant.

An improved device for handling such products, preferably for detaching those products from the plant or vine from which they have grown, with minimal damage to the plant and/or product, is therefore desired.

Aspects and embodiments of the present invention are set out in the appended claims. These and other aspects and embodiments of the invention are also described herein.

Described herein is a device for handling fresh fruit or vegetable products attached to a plant, comprising: means for retaining at least a first portion of a product; and means for engaging a second portion of the retained product; wherein the retaining means and engaging means are arranged such that, while a product is retained by the retaining means, the engaging means can be moved to detach the product.

Optionally, the engaging means is arranged to rotate the second portion of the retained product. Optionally, the retaining means and the engaging means are arranged to rotate together. Optionally, the retaining means is operable to rotate the first portion thereby causing the second portion to be rotated when engaged by the engaging means.

Optionally, the device further comprises means for rotating the retaining means, for example by applying a rotational force to the retaining means. Optionally, the rotating means comprises a motor arranged to provide a rotational drive output and a drive member arranged to be driven by the motor, preferably wherein the rotating means is arranged to provide continuous rotation of the retaining means. Optionally, the drive member is arranged to engage an exterior portion of the retaining means so as to provide direct rotational drive to the retaining means, for example wherein said drive member is a belt, strap or chain. Optionally, the rotating means comprises a gear and rack arrangement. Optionally, the retaining means is spring-loaded such that, following rotation of the retaining means from a first position to a second position, the retaining means is biased to return to the first position once the rotational force has been removed.

Optionally, the engaging means is arranged to inhibit movement of the second portion relative to the retained first portion when engaged therewith, for example wherein the engaging means is operable to clamp the second portion.

Also described herein is a device for handling fresh fruit or vegetable products attached to a plant, comprising: means for retaining at least a first portion of a product; and means for engaging a second portion of the retained product; wherein the engaging means is arranged to inhibit movement of the second portion relative to the retained first portion when engaged therewith.

Optionally, the engaging means comprises an annular member arranged to provide an aperture through which at least part of the second portion can be received. Optionally, the annular member is configured to have a variable diameter such that the aperture can be opened or closed about the second portion. Optionally, the annular member further comprises a plurality of cooperating portions arranged to move relative to each other during rotation of the retaining means so as to vary the diameter of the aperture. Optionally, the plurality of portions are operable to close the aperture around the second portion such that the annular member engages the second portion. Optionally, the engaging means is arranged to move the second portion to a position that is generally central of the aperture.

Optionally, the engaging means is operable to sever the second portion. Optionally, the device further comprises cutting means operable to sever the second portion. Optionally, the cutting means comprises pneumatic or electric shears.

Optionally, the further comprises means for securing said at least a portion of said retained product; wherein the securing means is arranged to secure at least said first portion in a desired position and/or orientation relative to the retaining means.

Also described herein is a device for handling fresh fruit or vegetable products, comprising: means for retaining at least a first potion of a product; and means for securing said at least a first portion of said retained product; wherein the securing means is arranged to secure at least said first portion in a desired position and/or orientation relative to the retaining means.

Optionally, the retaining means has an interior compartment arranged to receive at least the first portion of the product via an opening, and wherein the securing means is disposed within the retaining means. Optionally, the retaining means comprises a receptacle having an interior compartment arranged to receive the first portion via an opening in the receptacle. Optionally, the receptacle comprises a housing having an opening through which the first portion is received into the interior compartment of the housing, for example wherein the housing is cylindrical and/or in the form of a canister. Optionally, the retaining means comprises a mesh or frame structure, for example wherein the exterior of the retaining means does not provide a continuous solid surface.

Optionally, the engaging means is positioned at the opening of the retaining means. Optionally, the engaging means is part of the retaining means, for example wherein the engaging means is an integral part of the retaining means. Optionally, the securing means comprises one or more members that can be pulled tight about the product to secure it and loosened to release the product, preferably wherein the one or more members are flexible members.

Alternatively, or additionally, the securing means may comprise an inflatable member, wherein the inflatable member is arranged to inhibit movement of the first portion when inflated. Optionally, the inflatable bladder is arranged at least partially to surround at least the first portion of the product when inflated. Optionally, the bladder has a substantially U-shaped configuration when uninflated and a substantially C-shaped configuration when inflated. Optionally, the device further comprises means for connecting to an air supply for inflation of the inflatable bladder, wherein the connecting means is arranged to provide a connection with the air supply that allows the retaining means to be rotated relative to the air supply while maintaining an air seal, for example wherein the air supply comprises a hose or a similar air conduit.

Optionally, a sensor is arranged to detect the presence of a product within the retaining means and/or entering the retaining means. Optionally, a sensor is arranged to detect the orientation of a product retained by the retaining means. Optionally, the sensor(s) include a camera, for example an RGB camera.

Optionally, the device further comprises means for creating a partial vacuum for sucking a product thereby to position it relative to the retaining and/or engaging means. Optionally, the sucking means is arranged to suck the product into the retaining means.

Optionally, the retaining means is mounted to a support arranged to be connected to a mechanical device, optionally wherein the support has either a single or multiple-point attachment formation for attachment to the mechanical device.

Optionally, the retaining means is mounted to a support such that it can rotate relative to the support, preferably wherein the retaining means is rotatably mounted on one or more support components that are arranged to allow the retaining means to rotate relative to the support with minimal friction. Optionally, the support further comprises a quick-release mechanism configured to allow the device to be attached to and detached from a mechanical device, for example such that the device can be readily interchanged with a different device having a corresponding quick-release mechanism.

Optionally, the device is an end effector for a mechanical device, for example a robot arm.

According to another aspect, there is provided a robot arm comprising a device as described and/or claimed herein. Optionally, the robot arm is arranged to connect to two or more such devices.

According to another aspect, there is provided a support frame for mounting a plurality of devices as described and/or claimed herein. Optionally, each device is independently mounted, via springs, to the support frame to allow each device to move relative to the other device(s).

According to another aspect, there is provided a robot comprising a device and/or a robot arm as described and/or claimed herein.

According to another aspect, there is provided a device and/or method of operation as substantially described herein and/or illustrated in the accompanying drawings.

The fruit or vegetable product may be a tomato or a bell pepper, for example. The first portion may be a ‘preferred’ or ‘edible’ portion (such as the body of the product) and the second portion may be a ‘non-preferred’ or ‘non-edible’ portion (such as the stalk), for example. The device may act to break, tear or otherwise separate the second portion from (e.g. a stalk of) the plant to which the product is attached, thereby to detach the product, for example. Alternatively, or additionally, the first and second portions may be different portions of a stalk (or similar part) via which a product is attached to the plant.

In embodiments where the product is a tomato, the first portion may be the tomato body (or “fruit”) and the second portion may be the stalk that connects the tomato to its plant (e.g. the “peduncle”). In embodiments where the product is a bell pepper, the first portion may be the pepper body and the second portion may be (at least part of) the stalk that connects the bell pepper to its plant. The invention is of course not limited to handling these types of fruit and vegetable, which are simply illustrative examples of preferred products. Furthermore, the device is not limited to handling a fruit or vegetable product, but may be arranged to handle other (e.g. non-organic) articles or objects, preferably which have first and second portions.

As used herein, the term “end effector” preferably connotes a (e.g. mechanical) device or tool that is typically provided to at the end of a robot arm, such as grippers, vacuum suckers, and cutters for example. The end effector is usually the main part of a robot that interacts with the environment. As used herein, the term “handling” preferably includes harvesting, picking, holding, moving, collecting, and any other action that may be performed by a human hand in relation to a fruit or vegetable product.

As used herein, the term “retaining” preferably connotes keeping and/or holding, for example. As used herein, the term “receptacle” preferably connotes a form of container used to retain something, such as a fruit or vegetable. Such a receptacle is, preferably, hollow, and may further be described as a drum, can or canister, for example. As used herein, the term “iris mechanism” preferably connotes an arrangement of moveable portions forming an aperture which can open or close in a manner similar to an iris of an iris diaphragm, similar to a lens of a camera, for example.

Any apparatus feature as described herein may be provided as a method feature, and vice versa. Furthermore, as used herein, means plus function features may be expressed alternatively in terms of their corresponding structure. For example, the securing means may comprise an inflatable member, such as an inflatable bladder, as described above.

The invention extends to an apparatus and/or method for handling a fruit or vegetable product substantially as described herein and/or as illustrated in the accompanying figures.

At least one exemplary embodiment of the present invention will now be described with reference to the accompanying figures, in which:

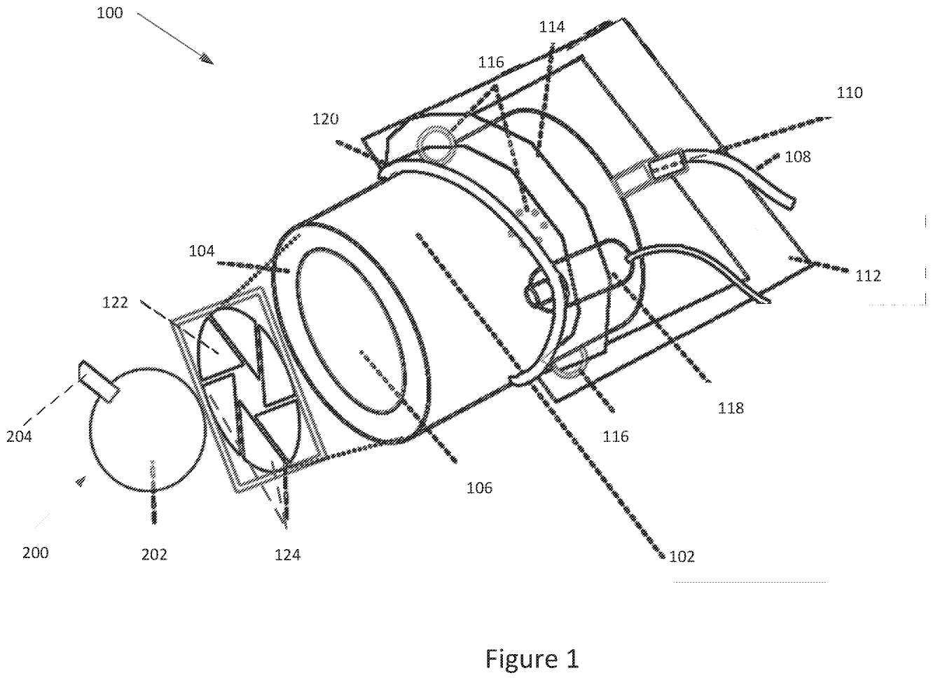

FIG. 1 shows an example of a device according to the invention;

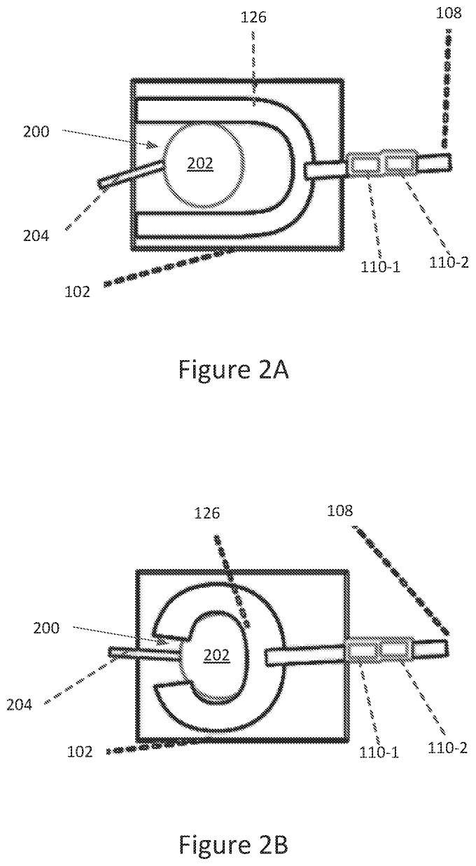

FIGS. 2A and 2B show how an inflatable member can retain a first portion of a product;

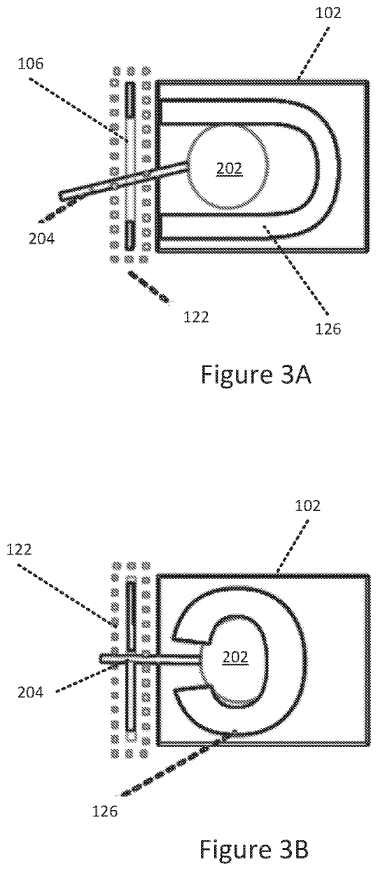

FIGS. 3A and 3B show a second portion of the product being engaged by the device;

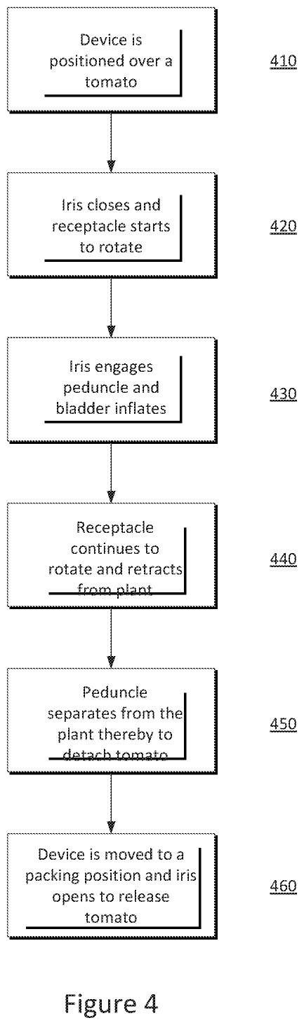

FIG. 4 shows an exemplary method of handling a product using the device; and

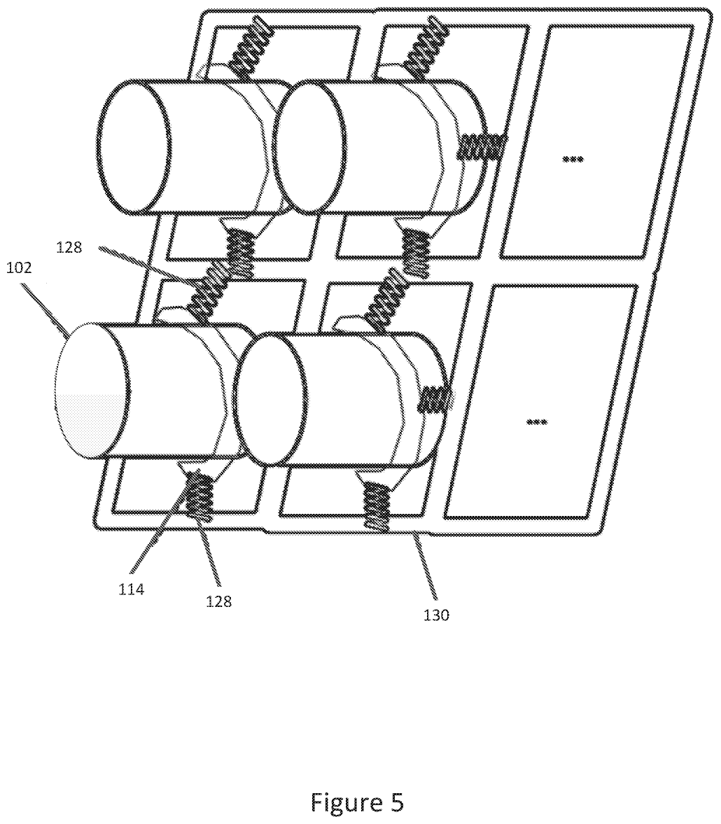

FIG. 5 shows multiple devices mounted on a support frame.

In the following description and accompanying drawings, corresponding features of different embodiments are, preferably, identified using corresponding reference numerals.

As shown in FIG. 1, an end effector device 100 according to the present invention includes a receptacle 102 in the form of a cylindrical housing. The receptacle 102 (i.e. a “retaining means”) has a first open end 104 forming an aperture (or “opening”) 106, for receiving a fruit or vegetable product 20 into the receptacle 102, and a second end.

A tomato 200 (e.g. a fruit “product”) having a body 202 (e.g. “first portion”) and a peduncle 204 (e.g. “second portion”) is shown about to be received into the receptacle 102 via the aperture 106. For simplicity, the device 100 will be described hereinafter with reference to a tomato 200, though it will of course be appreciated that a tomato is only one example of a “product” (or indeed an “object”) that the device 100 can handle.

An iris mechanism 122 (i.e. an “engaging means”) is provided at the open end 104 of the receptacle 102. Once the body 202 of the tomato 200 is retained within the receptacle 102, the iris mechanism 122 is operable to engage the peduncle 204 of the tomato 200 that extends through the aperture 106. Preferably, the iris mechanism 122 closes in such a way to orientate the peduncle 204 generally centrally of the iris mechanism 122, and thus orientate also the body 202. Thus, when the iris mechanism 122 is closed to engage the peduncle 204, the peduncle 204 is ideally moved to be orthogonal to the body 202 of the tomato 200 retained within the receptacle 102.

The iris mechanism 122 comprises an annular (ring) member that surrounds a plurality of moveable portions (e.g. “blades” or “petals”) 124-1, 124-2 . . . 124-n arranged to close (or cover) the aperture 106, thereby to engage the peduncle 204 of the tomato 200. The plurality of moveable portions 124 are configured to form an iris diaphragm, similar to that often used in a camera lens, which may be opened and closed. The iris diaphragm may contain between 2 and 20 moveable portions 124. In one embodiment, two (opposing) moveable portions 124 may be arranged at right-angles to create a square aperture that moves the peduncle 204 to the centre of the aperture 106 when the iris mechanism 122 is closed.

The surface material of the iris mechanism 122 and/or the moveable portions 124 may be configured to provide a friction engagement with the peduncle 204 of the tomato 200 thereby to avoid excess damage. The iris mechanism 122 may also include one or more sensors (not shown) arranged to detect if the tomato 200 is sufficiently centred within the aperture 106. The sensors might be placed in the moveable portions 124, the annular (ring) member of the iris mechanism 122 or external of the receptacle 102 (e.g. camera checking position).

The iris mechanism 122 is caused to open and close by rotation of the receptacle 102. The receptacle 102 can therefore be rotated in either direction.

An air supply (hose) 108 may be attached to the receptacle 102, preferably at the closed end, via a coupling 110, which will be described in more detail below. The coupling 110 that fluidly connects the air hose 108 to the inflatable bladder 126 inside the receptacle 102 comprises a first part 110-1 and a second part 110-2, which are connected together so as to allow continuous rotation of the first part 110-1 relative to the second part 110-2 without disrupting air flow though the hose 108. For example, the first and second parts 110-1, 110-2 of the coupling 110 may comprise a rotary union and/or a rotary joint to inhibit twisting of the air supply hose 108 from restricting movement of the end effector 100 (or damage it). As an alternative, the air supply may be local, powered using a cylinder or local air pump, rather than a remotely connected air supply.

FIGS. 2A and 2B are schematic sectional views showing an interior compartment of the receptacle 102. An inflatable bladder 126 (i.e. an “inflatable member”) is disposed within the receptacle 102. The inflatable bladder 126 is connected to the air supply hose 108. The inflatable bladder 126 is configured such that, when deflated, the tomato 200 can be received into, and removed from, the receptacle 102, as shown in FIG. 2A. When the inflatable bladder 126 is inflated, via the air supply 108, it forms a general ‘C shape’ that substantially encompasses the first portion 202 of the tomato 200, thereby securing it within the receptacle 102, as shown in FIG. 2B. Thus, when inflated, the inflatable bladder 126 inhibits movement of the body 202 of the tomato 200 within the receptacle 102, for example to inhibit rotation of the tomato 200 and/or slippage of the tomato 200 relative to the inflatable bladder 126.

As shown in schematic FIGS. 3A and 3B, when a tomato 200 is disposed within the receptacle 102, its peduncle 204 extends though the aperture 106 of the receptacle 102 and thus through the iris mechanism 122. Prior to inflation of the inflatable bladder 126, the peduncle 204 is free to rest though or on the iris mechanism 122, as shown in FIG. 3A. As the iris mechanism 122 closes, it engages the peduncle 204 by gripping it between the moveable portions 124-1, 124-2, etc., as shown in FIG. 3B. At the same time, the peduncle 204 is moved to a position that is generally central of the aperture 106, which may cause the body 202 of the tomato 200 to be moved (or orientated) within the receptacle 102 accordingly. The inflatable bladder 126 is then inflated, preferably once the iris mechanism 122 has dosed, to secure the body 202 of the tomato 200 within the receptacle 102.

Subsequent movement of the receptacle 102 relative to the plant (not shown), to which the tomato 200 is attached, causes the peduncle 204 to separate and/or tear, thereby detaching the tomato 200 from the plant. The relative movement is preferably a rotational movement, whereby the tomato 200 undergoes a twisting motion that mimics manual detachment of the tomato 200 by hand. Additionally, and/or alternatively, once secured in the receptacle 102, the device 100 may be retracted from the plant to detach the tomato 200.

In another embodiment, the iris mechanism 122 may (further) provide a cutting function that severs the stalk or stem of the fruit or vegetable product 200 to detach it, for example if one or more of the moveable portions 124 of the iris mechanism 122 is provided with a cutting edge. Alternatively, or in addition, a separate cutting mechanism (e.g. “cutting means”) (not shown) may be provided for severing the stalk or stem, such as a blade or shears, for example.

Turning again to FIG. 1, the receptacle 102 is mounted to a support frame 112. The receptacle 102 is mounted to the support frame 112 via a support bracket 114 in the form of an annular ring. A plurality of bearings 116 (for example, three) are spaced around the support bracket 114 to facilitate rotation of the receptacle 102 relative to the support bracket 114. Furthermore, axial movement of the receptacle 102 may be limited relative to the support bracket 116, such that only relative rotation is permitted.

An electric motor 118 (e.g. “means for rotating”) is mounted on the support bracket 114. The electric motor 118 is arranged to provide rotational drive to the receptacle 102 so as to cause it to rotate relative to the support bracket 114. The electric motor 118 is coupled to the receptacle 102 via a drive member 120, which is shown here as a drive belt. The drive belt 120 directly engages the receptacle 102, and may therefore comprise rubber or another suitably elastic material that provides a friction engagement, for example. The drive belt 120 is rotatably driven by the electric motor 118, which in turn causes the receptacle 102 to rotate. In other words, the electric motor 118 applies a rotational force to the receptacle 102. The motor 118 may be controlled to drive rotation in either direction. The drive member 120 may alternatively comprise a strap or chain, or a gear and rack arrangement, for example.

At least part of an exemplary mode of operation will now be described, with reference to a tomato being handled by the end effector device 100, and the steps illustrated in FIG. 4, as follows:
Step 410: The end effector device 100 is moved into position over a tomato 200 such that the body 202 of the tomato 200 is received into the receptacle 102.
Step 420: The iris mechanism 122 starts to close around the peduncle 204 of the tomato 200 and the receptacle 102 is slowly rotated by the electric motor 118.
Step 430: The iris mechanism 122 engages the peduncle 204 and the inflatable bladder 126 (disposed inside the receptacle 102) inflates around the body 202 of the tomato 200 to retain it.
Step 440: The receptacle 102 continues to rotate, thereby rotating the tomato 200. As the receptacle 102 rotates, it retracts from the tomato plant.
Step 450: The peduncle 204 separates from the tomato plant (or a stalk thereof).
Step 460: The end effector device 100 moves to a packing position, at which point the inflatable bladder 126 deflates. The iris mechanism 122 then opens to release the tomato 200 into the packaging.

This is of course only an exemplary mode of operation, and other modes of operation may be possible within the scope of the invention.

FIG. 5 shows a support frame 130, in the form of an “x/y sprung bracket”. Multiple receptacles 102 are independently supported in the support frame 130 by springs 128 (or similar resilient means), which allow the receptacles 102 a degree of movement, for example to absorb minor impacts. Preferably, each receptacle 102 is supported by two pairs of opposing springs 128 arranged to allow/control movement in both the x-axis and y-axis, relative to the bracket 130.

By supporting multiple receptacles 102 on a single bracket 130, multiple tomatoes (i.e. “products”/“objects”) can therefore be picked simultaneously from a single tomato truss (not shown), for example, whilst allowing for organic variation in growth shape/sizes. The springs 128 may allow receptacles 102 to move forward and backward within the support frame 130. This may allow the support frame 130 to be advanced towards a tomato truss when one or more receptacle 102 already retains a tomato thereby to capture tomatoes that are deeper in the truss in empty receptacles 102 while allowing already filled receptacles 102 to lag behind, which may help to prevent damage to the tomatoes and/or plant from which they are grown. The support frame 130 may be attached to a single robot (arm). Multiple robot arms may each be attached to a support frame 130 for enhanced efficiency.

Possible alternatives & extensions may include any of the following:

The retaining means may be a gripper mechanism (e.g. similar to a robot “hand”) arranged to grip (and thereby retain/receive) a product, or a first and/or second portion thereof. The retaining means and the engaging means may be provided by the same component, for example, such as the gripper mechanism. A means for sucking (e.g. a “suction device”) may be arranged to suck a product into and/or to position it relative to the retaining and/or engaging means. The suction device may be arranged to create a partial vacuum to suck in the product. A second robot or fixed arm may be used to position the product into the retaining means.

One or more sensors may be arranged to detect whether a fruit/vegetable product is within, or is entering the receptacle, and its (e.g. relative) position. Sensors may be arranged to provide force-feedback to indicate how securely a product is retained and/or to indicate a collision. The receptacle may be directly mounted to a robot (arm) that can be continuously rotation in either/both directions instead of requiring a support bracket and/or ring. The end effector device may be adapted such that it is easily and/or automatically interchangeable with another end effector device, for example whereby it is provided with a quick release mechanism (not shown).

Multiple end effector devices could be attached to the same robot (arm) to allow multiple products to be handled (e.g. picked) simultaneously. The robot (arm) may be connected directly to the support frame. The device may be made from metal/plastic/other material in whole or part.

It will be understood that the present invention has been described above purely by way of example, and modifications of detail can be made within the scope of the invention.

Furthermore, any feature in a particular aspect described herein may be applied to another aspect, in any appropriate combination. It should also be appreciated that particular combinations of the various features described and defined in any aspects described herein can be implemented and/or supplied and/or used independently.

What is claimed is:

1. A device for handling fresh fruit or vegetable products attached to a plant, comprising:
means for retaining at least a first portion of a product; and
means for engaging a second portion of the retained product;
wherein the retaining means and engaging means are arranged such that, while a product is retained by the retaining means, the engaging means can be moved to detach the product.

2. The device of claim 1, wherein the engaging means is arranged to rotate the second portion of the retained product.

3. The device of claim 1 or 2, wherein the retaining means and the engaging means are arranged to rotate together.

4. The device of any of claims 1 to 3, wherein the retaining means is operable to rotate the first portion thereby causing the second portion to be rotated when engaged by the engaging means.

5. The device of any preceding claim, further comprising means for rotating the retaining means, for example by applying a rotational force to the retaining means.

6. The device of claim 5, wherein the rotating means comprises a motor arranged to provide a rotational drive output and a drive member arranged to be driven by the motor, preferably wherein the rotating means is arranged to provide continuous rotation of the retaining means.

7. The device of claim 6, wherein the drive member is arranged to engage an exterior portion of the retaining means so as to provide direct rotational drive to the retaining means, for example wherein said drive member is a belt, strap or chain.

8. The device of claims 5 to 7, wherein the rotating means comprises a gear and rack arrangement.

9. The device of claim 8, wherein the retaining means is spring-loaded such that, following rotation of the retaining means from a first position to a second position, the retaining means is biased to return to the first position once the rotational force has been removed.

10. The device of any of the preceding claims, wherein the engaging means is arranged to inhibit movement of the second portion relative to the retained first portion when engaged therewith, for example wherein the engaging means is operable to clamp the second portion.

11. A device for handling fresh fruit or vegetable products attached to a plant, comprising:
means for retaining at least a first portion of a product; and
means for engaging a second portion of the retained product;
wherein the engaging means is arranged to inhibit movement of the second portion relative to the retained first portion when engaged therewith.

12. The device of claim 10 or 11, wherein the engaging means comprises an annular member arranged to provide an aperture through which at least part of the second portion can be received.

13. The device of claim 12, wherein the annular member is configured to have a variable diameter such that the aperture can be opened or closed about the second portion.

14. The device of claim 13, wherein the annular member further comprises a plurality of cooperating portions arranged to move relative to each other during rotation of the retaining means so as to vary the diameter of the aperture.

15. The device of claim 14, wherein the plurality of portions are operable to close the aperture around the second portion such that the annular member engages the second portion.

16. The device of any of claims 12 to 15, wherein the engaging means is arranged to move the second portion to a position that is generally central of the aperture.

17. The device of any of the preceding claims, wherein the engaging means is operable to sever the second portion.

18. The device of any of the preceding claims, further comprising cutting means operable to sever the second portion.

19. The device of claim 18, wherein the cutting means comprises pneumatic or electric shears.

20. The device of any of the preceding claims, further comprising means for securing said at least a portion of said retained product; wherein the securing means is arranged to secure at least said first portion in a desired position and/or orientation relative to the retaining means.

21. A device for handling fresh fruit or vegetable products, comprising:
means for retaining at least a first potion of a product; and
means for securing at least said first portion of said retained product;
wherein the securing means is arranged to secure said at least a first portion in a desired position and/or orientation relative to the retaining means.

22. The device of claim 20 or 21, wherein the retaining means has an interior compartment arranged to receive at least the first portion of the product via an opening, and wherein the securing means is disposed within the retaining means.

23. The device of any of the preceding claims, wherein the retaining means comprises a receptacle having an interior compartment arranged to receive the first portion via an opening in the receptacle.

24. The device of claim 23, wherein the receptacle comprises a housing having an opening through which the first portion is received into the interior compartment of the housing, for example wherein the housing is in the form of a cylindrical housing or canister.

25. The device of any preceding claim, wherein the retaining means comprises a mesh or frame structure, for example wherein the exterior of the retaining means does not provide a continuous solid surface.

26. The device of any of claims 22 to 25, wherein the engaging means is positioned at the opening of the retaining means.

27. The device of any of the preceding claims, wherein the engaging means is part of the retaining means, for example wherein the engaging means is an integral part of the retaining means.

28. The device of any of claims 20 to 27, wherein the securing means comprises one or more members that can be pulled tight about the product to secure it and loosened to release the product, preferably wherein the one or more members are flexible members.

29. The device of any of claims 20 to 27, wherein the securing means comprises an inflatable member, wherein the inflatable member is arranged to inhibit movement of the first portion when inflated.

30. The device of claim 29, wherein the inflatable bladder is arranged at least partially to surround at least the first portion of the product when inflated

31. The device of claim 30, wherein the bladder has a substantially U-shaped configuration when uninflated and a substantially C-shaped configuration when inflated.

32. The device of any of claims 29 to 31, further comprising means for connecting to an air supply for inflation of the inflatable bladder, wherein the connecting means is arranged to provide a connection with the air supply that allows the retaining means to be rotated relative to the air supply while maintaining an air seal, for example wherein the air supply comprises a hose or a similar air conduit.

33. The device of any of the preceding claims, further comprising a sensor arranged to detect the presence of a product within the retaining means and/or entering the retaining means.

34. The device of any of the preceding claims, comprising a sensor arranged to detect the orientation of a product retained by the retaining means.

35. The device of claim 33 or 34, wherein the sensor(s) include a camera, for example an RGB camera.

36. The device of any of the preceding claims, further comprising means for creating a partial vacuum for sucking a product thereby to position it relative to the retaining and/or engaging means.

37. The device of claim 36, wherein the sucking means is arranged to suck the product into the retaining means.

38. The device of any of the preceding claims, wherein the retaining means is mounted to a support arranged to be connected to a mechanical device, optionally wherein the support has either a single or multiple-point attachment formation for attachment to the mechanical device.

39. The device of any of the preceding claims, wherein the retaining means is mounted to a support such that it can rotate relative to the support, preferably wherein the retaining means is rotatably mounted on one or more support components that are arranged to allow the retaining means to rotate relative to the support with minimal friction.

40. The device of claim 39, wherein the support further comprises a quick-release mechanism configured to allow the device to be attached to and detached from a mechanical device, for example such that the device can be readily interchanged with a different device having a corresponding quick-release mechanism.

41. The device of any preceding claim, wherein the device is an end effector for a mechanical device, for example a robot arm.

42. The device of any preceding claim, wherein the product is a tomato.

43. The device of any preceding claim, wherein the product is a bell pepper.

44. A robot arm comprising a device according to any of the proceeding claims.

45. The robot arm of claim 44, further being arranged to connect to two or more devices according to any of claims 1 to 41.

46. A support frame for mounting a plurality of devices according to any of claims 1 to 41, wherein each device is independently mounted, via springs, to the support frame to allow each device to move relative to the other device(s).

47. A robot comprising a device and/or a robot arm according to any of the preceding claims.

48. A device as substantially described herein and/or illustrated in the accompanying drawings.

49. A method of operation as substantially described herein and/or illustrated in the accompanying drawings.
